(19) United States
(12) Patent Application Publication
(10) Pub. No.: US 2016/0132109 A1
(43) Pub. Date: May 12, 2016

(54) Command glove

(71) Applicant: Brandon Hardin, Knoxville, TN (US)

(72) Inventor: Brandon Hardin, Knoxville, TN (US)

(73) Assignee: Brandon Hardin, Knoxville, TN (US)

(21) Appl. No.: 14/757,014

(22) Filed: Nov. 9, 2015

Related U.S. Application Data
(60) Provisional application No. 62/076,283, filed on Nov. 6, 2014.

(51) Int. Cl. G06F 3/01; A41D 19/00

(52) U.S. Cl. CPC G06F 3/014; A41D 19/0024

(57) ABSTRACT

Glove embedded with sensors for interfacing functions of an electronic device is disclosed. Invention allows for manipulation of the basic controls of an electronic device with one hand and without looking at the device or the control apparatus.

### CLAIM OF PRIORITY

The applicant claims for this application the priority date established by provisional patent application 62/076,283, filed on Nov. 6, 2014.

### FIELD OF THE INVENTION

The invention relates to one-handed and eyes-free control of electronic devices.

### BACKGROUND OF THE INVENTION

Due to the multiple tasks performed while simultaneously controlling electronic devices, such as smart phones, the ability to perform such controlling functions without the need to look at the electronic device, and the ability to perform such controlling functions with one hand, would be advantageous.

For example, people engaged in physical activity while also listening to their mobile audio/visual player often want to manipulate the controls (i.e. volume, tract select) of the device but do not want to interrupt their stride or continued activity by physically looking down at the device or grabbing a remote control to manipulate the device. Currently, means of control hanging from a headset or located directly on a small device, often require the use of both arm and hand in order to grab and then manipulate the control buttons or icons. Such controls, in the case of a runner or walker, impede their natural stride. More importantly such controls cause the individual to look away from the running or walking path, increasing the likelihood of accidents.

The current invention allows for manipulation of the basic controls of audio players, smart phones, and similar electronic devices without drastically impeding the activity or natural stride of the user.

Additionally, answering mobile phones and manipulating controls on such phones often leads to distracted driving. Such distracted driving causes significant loss of life and property every year.

For these and many other reasons, the ability to control mobile electronic devices with one hand, and without the need to look at the device, would be advantageous.

### SUMMARY OF THE INVENTION

For purposes of this application the following terms shall have the following meanings, unless specifically stated otherwise, or context clearly reflects a different meaning:

Bluetooth shall mean: “a wireless networking technology that uses short-wave radio frequencies to interconnect cell phones, portable computers, and other wireless electronic devices.”

Circuit shall mean: “a discrete path between two or more points along which signals can be carried.”

Mobile phone shall mean: “a wireless handheld device that allows users to make calls or send text messages or connect to the internet, and that does not require the use of landlines.”

Tablet shall mean: “A general-purpose computer contained in a touchscreen panel.”

An object of the present invention provides a system and method for controlling mobile electronic devices with one hand, and without the need to look at the device. More specifically, the present invention discloses a new glove with integrated controls and circuits designed to take advantage of peoples' natural ability to accurately touch fingertips to specific points on the persons' hand without having to look at the finger or hand. The present invention also provides methods for use of such a glove.

The components for the current invention include a glove or other means to apply sensors to a hand, sensors and circuits designed to detect closing of specific circuits upon touch of fingertip sensors to other sensors at various locations around the hand, a power source, and a means of interfacing the command glove with an electronic device.

A preferred embodiment includes a glove; one primary sensor at the tip of the glove's thumb; and twelve secondary sensors at the tip of each of the four fingers, between the first and second joint of each of the four fingers, and between the second and third joint of the four fingers; a microchip; a power source; and a Bluetooth circuit for interfacing the command glove with an electronic mobile device. Each of the twelve available secondary sensors are portions of twelve individual circuits that may be closed by touching the primary sensor, in the thumbtip of the glove, to any one of the twelve other sensors. The Bluetooth and/or electronic device is pre-programmed to interpret the closing of each circuit as a separate command for the electronic device. For example, closing the first circuit by touching the tips of the thumb and index finger is interpreted by the electronic device as touching the “play” button for an audio device. Similarly, touching the middle fingertip to the thumbtip is interpreted by a mobile phone as touching the answer button to answer a phone call.

In an alternate embodiment the invention does not include a primary sensor in the glove. Instead the secondary sensors, placed at various locations around the hand, are comprised of sensors or buttons that complete an individual circuit upon being pressed by the thumb.

In the preferred embodiment each circuit is used for more than one function. For example, the first touch between the primary sensor and a secondary sensor is interpreted as touching the play button of an electronic device, while a second touch between the same sensors is interpreted by the electronic device as touching the pause button. Similarly, the first touch between the primary sensor and a secondary sensor is interpreted as touching the answer button of a mobile phone, while a second touch between the same sensors is interpreted by the mobile phone as touching the hang up button. In these examples a third touch to the same sensor is interpreted as the same as a first touch. In other words, a first and second touch of any given secondary, sensor acts as an on/off toggle for the selected function associates with the given sensor. Therefore, in the preferred embodiment at least twenty four different functions are controlled by one command glove.

In another embodiment each of multiple touches of any given circuit, control different functions of the electronic device.

In another embodiment the invention has only one primary sensor and only one secondary sensor.

In another embodiment the invention has only one primary sensor and four secondary sensors, one on each of the four fingertips.

In other embodiments the invention has different numbers and configurations of sensors in various positions around the hand.

In other embodiment the means of interfacing the command glove with an electronic device is a wired connection, or alternatively a means of utilizing radio frequency or infrared communication between circuits in the glove and circuits in the electronic device.

The electronic devices for which the command glove can interface include, but are not limited to, mobile phones, electronic tablets, laptop computers, desktop computers, video games, televisions, radios, remote control devices, cameras, smart boards, audio recording devices, stereos, and scoreboards.

These aspects, and others, that will become apparent to the artisan upon review of the following description, can be accomplished through the following process: Assemble the glove by embedding the function sensors on the fingers of the glove, excluding the thumb, between the joints to allow for natural movement of the hand. The primary, or “Select,” sensor is embedded on the pad of the thumb (second phalanx) and above the joint to allow for natural movement. The circuitry is configured so that when the select sensor comes into contact with the individual function sensors the assigned functions are accomplished on the electronic device via a Bluetooth, or wired connection, or other means of interfacing between the glove and the electronic device.

To use the instant invention the user wears the glove and interfaces it with the selected electronic device. The means of interfacing, and/or the electronic device are programmed to allow control of the basic functions of the electronic device by closing of specific circuits imbedded within the glove.

The specific functions for each circuit can be reassigned or reprogrammed to control a wide variety of functions for any given electronic device.

It is to be understood that both the foregoing general description and the following detailed description provide embodiments of the invention and are intended to provide an overview or framework of understanding the nature and character of the invention as it is claimed.

### DESCRIPTION OF THE DRAWINGS

FIG. 1 is a block diagram representing an overview of the method involved in controlling an electronic device with the instant invention.

FIG. 2 is an exemplary diagram of the preferred embodiment on a hand with primary and secondary sensors of the instant invention integrated into a glove. (Hereinafter, the “Command Glove”).

FIG. 3 is an exemplary diagram of another embodiment on a hand with only secondary sensors of the instant invention integrated into a glove on the four fingers.

### DETAILED DESCRIPTION OF THE INVENTION

The present invention provides methods and a system for one-handed and eyes-free control of electronic devices, which is described more fully hereinafter. This invention may be embodied in many different forms and should not be construed as limited to the specific embodiments described herein.

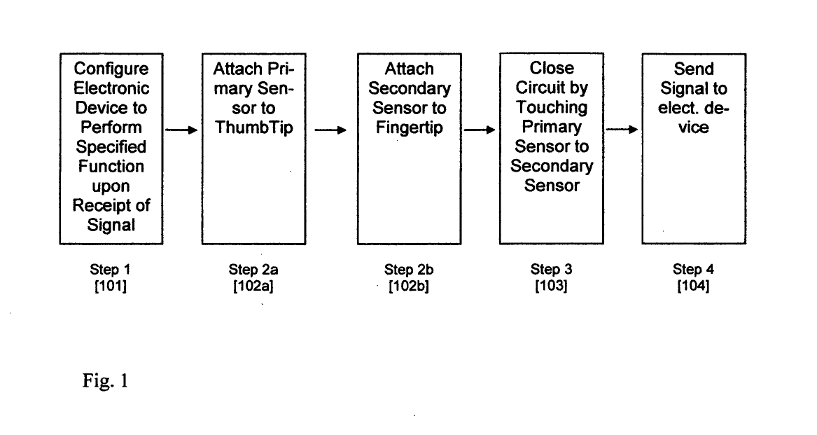

FIG. 1 is a block diagram representing an overview of the method involved in controlling an electronic device with the instant invention. Step one [101] includes configuring an electronic device to receive signals from the Command Glove. Said configuration includes programming the electronic device to perform functions upon receiving a signal from the Command Glove. In the simplest version of the instant invention only one type of signal is sent to the electronic device from the Command Glove, representing closing of one circuit by touching the primary sensor to a single secondary sensor. Such a simple version of the instant invention controls two functions of the electronic device by designating the first function to be performed upon closing of the circuit, and designating the second function to be performed upon opening the circuit. Alternatively, two functions are controlled by designating the first function to be performed upon the first closing of the circuit, and designating the second function to be performed upon the second closing the circuit. In this manner a single circuit controls multiple functions. The scope of the instant invention includes control of a single function per circuit, and control of multiple functions per circuit. In the preferred embodiment twelve circuits are available and are controlled by manipulation of sensors on a single hand. However, the scope of the instant invention includes as many sensors as can be fitted and controlled on a single hand.

Step 2a [102] includes attaching a primary sensor to the user's thumb. In the preferred embodiment the primary sensor is attached to the tip of the thumb.

Step 2b [103] includes attaching a secondary sensor to any portion of the hand to which the primary sensor has been attached. The secondary sensor is placed in a location to which the primary sensor can be touched by natural movement of the hand. In the preferred embodiment the primary sensor is attached to the tip of the index finger. More than one secondary sensors may be included. In the preferred embodiment twelve secondary sensors are attached to the hand, giving a total of twelve independent circuits.

Note that the scope of the current invention includes performing steps 1 [101], 2a [102a], and 2b [102b] in any order, or simultaneously. In the preferred embodiment the primary and secondary sensors are integral to a glove that is placed on the user's hand (Command Glove), thereby essentially performing steps 2a [102a], and 2b [102b] simultaneously. Also, the preferred embodiment includes configuring the electronic device to perform the specified function or functions associated with specified signals from the Command Glove, prior to use of the Command Glove. However, the scope of the instant invention includes simultaneously configuring the electronic device and placing the primary and secondary sensors, and all combinations of orders of said steps.

Step 3 [103] includes closing a selected circuit by touching the primary sensor to the selected secondary sensor. Said closing of the selected circuit causes step 4 [104] sending a signal to the electronic device. Said sending [104] may be by means of one or more separate components sending a signal or signals, or by means of the closed circuit directly causing the electronic device to perform a specified function.

In the preferred embodiment the signal sent [104] from the Command Glove to the electronic device is one of multiple potential signals associated with one of the several circuits available for selection by the user. In the preferred embodiment each circuit controls at least one specified function command.

In various embodiments the method results in the user being able to control multiple functions of the electronic device with one hand and without having to look at the electronic device or any other control mechanism. Because the user knows where his thumb and fingers are, and can touch his thumbtip to a selected fingertip without having to look at his hand, the user can control various functions one-handed and eyes-free. For example, the user is able to play music on an audio player, pause the player, increase and decrease volume, and skip songs, all with one handed control and without having to look at the audio player.

In another example a driver, using the Command Glove, is able to pick up a call on a mobile phone, increase and decrease volume, hang up, place a caller on hold, and perform many other functions with the mobile phone, all without letting go of the steering wheel or looking away from the road.

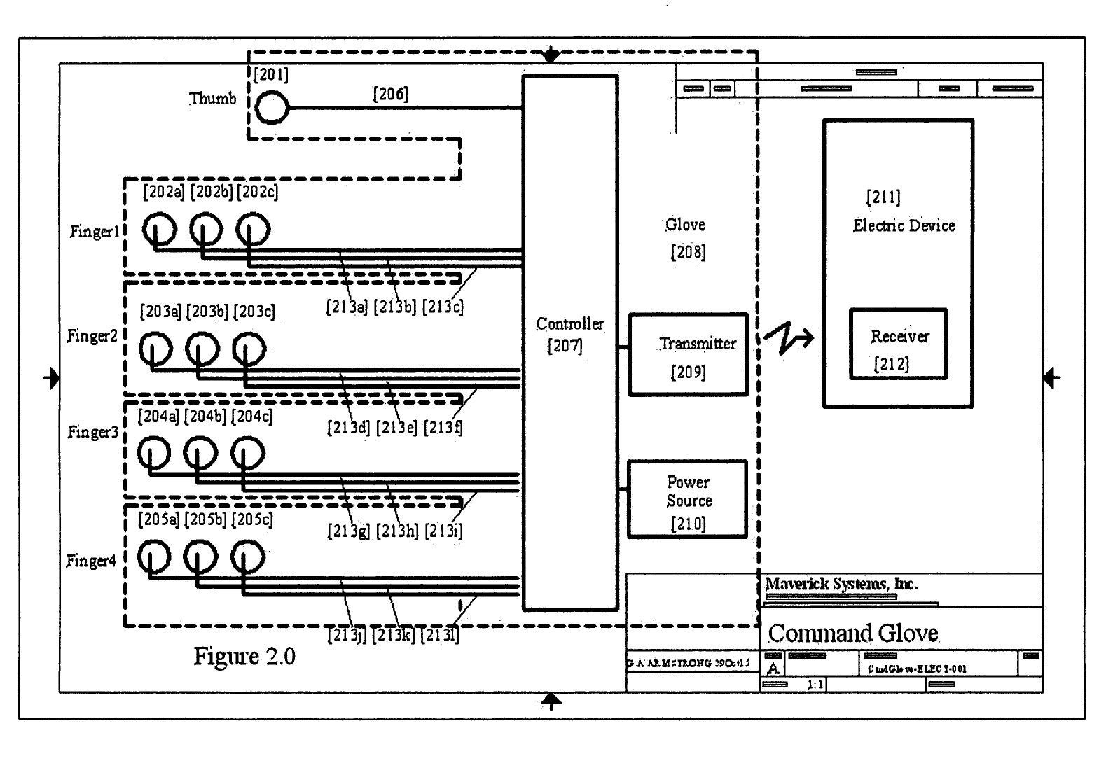

FIG. 2 is an exemplary diagram of the preferred embodiment on a hand with primary and secondary sensors of the instant invention integrated into a Command Glove [208]. The primary sensor [201] is embedded within the palm side of the glove at the end of the thumb. Twelve secondary sensors [202a], [202b], [202c], [203a], [203b], [203c], [204a1], [204b], [204c], [205a], [205b], [205c] are embedded within the glove at twelve different locations on the four fingers. Four secondary sensors are embedded on the palm side of the glove at the fingertips [202a], four more secondary sensors are embedded on the palm side of the glove between the second and third joint of the four fingers [202b], and four more secondary sensors are embedded on the palm side of the glove between the first and second joints of the four fingers [202c].

In the preferred embodiment the primary sensor [201] and all secondary sensors [202a]-[205c] are embedded within material configured as a glove to be worn by the user. The sensors [201] and [202a]-[205c] are insulated between the user's skin and the sensor, but are exposed on the exterior of the glove to allow direct contact between the primary sensor [201] and any one of the secondary sensors [202a]-[205c] via natural movement of the hand, touching the primary sensor [201] in the thumbtip to a portion of one of the fingers containing any specific secondary sensor [202a]-[205c].

The primary sensor [201] is electrically connected to a controller [207] via electrically conductive wire [206] running from the primary sensor [201] to the controller [207]. The wire [206] is insulated and embedded within the material of the Command Glove. In alternate embodiments the primary sensor [201] is electrically connected to the controller [207] via any conductive material.

Each of the secondary sensors [202a]-[205c] are independently connected to the controller [207] with a separate electrically conductive wire [213a]-[216c] running from each secondary sensors [202a]-[205c] to the controller [207]. In the preferred embodiment the wires [213a]-[216c] are embedded within the material of the Command Glove in a manner that minimizes the wires' [213a]-[216c] visibility and profile. An individual circuit is closed each time the primary sensor [201] touches any of the secondary sensors [204a]-[205c].

The controller [207] is connected to a power source [210]. In the preferred embodiment the power source [210] is a small battery. Other power sources are within the scope of the instant invention.

The controller [207] is also connected to a transmitter [209]. The controller [207] is configured to control the transmitter [209] such that the transmitter [209] sends various signals to a receiver [212] within an electronic device [211] in a manner controlled by the closing and opening of the various circuits created by contacting the primary sensor [201] to various secondary sensors [202a]-[205c]. In the preferred embodiment the transmitter [209] is a Bluetooth, and the electronic device [211] is a mobile phone or tablet or audio player.

For example, the user places a hand within a Command Glove. The glove includes a primary sensor in the thumbtip and numerous secondary sensors at various locations in the fingers. The user turns on the Command Glove by pressing a button on the top wrist section of the glove which is connected to the power source. Upon power up the Bluetooth transmitter embedded within the glove interfaces with a mobile phone via programming contained within the Bluetooth and the mobile phone. The user turns on the phone by touching the thumbtip sensor to the pinkytip sensor. The user may turn off the phone by touching the thumbtip sensor to the pinkytip sensor a second time. The user answers a call by touching the thumbtip sensor to the index finger sensor. The user hangs up the call by touching the thumbtip sensor to the index finger sensor a second time. The user redials the last number called by touching the thumbtip sensor to the middle sensor on the index finger. The user redials the last number received by touching the thumbtip sensor to the lowest sensor on the index finger. The user increases volume by repeatedly touching the thumbtip sensor to the middle finger tip. The user decreases volume by repeatedly touching the thumbtip sensor to the middle sensor on the middle finger. The user switches the phone from phone mode to Pandora by touching the thumbtip sensor to the lowest middle finger sensor. The user mutes the current application running on the phone by touching the thumbtip sensor to the middle sensor on the pinky finger.

As can be deduced by these examples, a large variety of functions for practically any electronic device can be controlled via simple commands by touching one thumb to a fingertip.

Because of the innate ability to accurately touch thumbtip to different desired parts of the hand without having to look at the hand, the Command Glove enables the user to perform all of the above functions, and many others, with one hand, and without looking at the electronic device or any control mechanisms. This is one-handed, eyes-free control.

It is apparent that many modifications and variations of this invention as set forth above may be made without departing from the spirit and scope. The specific embodiments described are given by way of example only, and the invention is limited only by the terms of the appended claims.

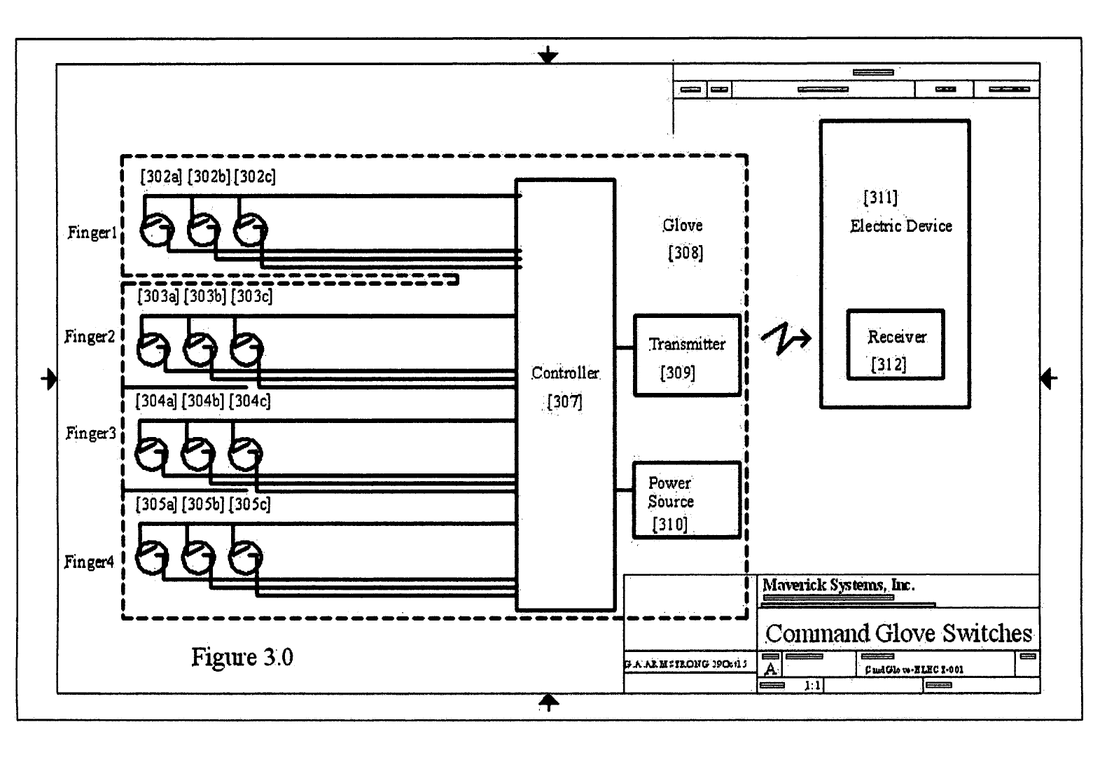

FIG. 3 is an exemplary diagram of an alternate embodiment on a hand with no primary sensor and twelve secondary sensors [302a]-[305c] of the instant invention integrated into a Command Glove at the four fingers. The twelve secondary sensors [302a], [302b], [302c], [303a], [303b], [303c], [304a], [304b], [304c], [305a], [305b], [305c] are embedded within the glove at twelve different locations on the four fingers. Four of the secondary sensors are embedded on the palm side of the glove at the fingertips [302a]-[305a], four more secondary sensors are embedded on the palm side of the glove between the second and third joint of the four fingers [302b]-[305b], and four more secondary sensors are embedded on the palm side of the glove between the first and second joints of the four fingers [302c]-[305c].

In one embodiment all secondary sensors [302a]-[305c] are embedded within material configured as a glove to be worn by the user. The sensors [302a]-[305c] are insulated between the user's skin and the sensor, and on the exterior of the glove.

The all sensors [302a]-[305c] are electrically connected to a controller [307] via electrically conductive wire running from each sensor [302a]-[305c] to the controller [307]. The wire is insulated and embedded within the material of the Command Glove. In alternate embodiments each sensor [302a]-[305c] is electrically connected to the controller [307] via any conductive material.

Each of the secondary sensors [302a]-[305c] is independently connected to the controller [307] with separate electrically conductive wire running from each secondary sensors [302a]-[305c] to the controller [307]. In the preferred embodiment the wires are embedded within the material of the Command Glove in a manner that minimizes the wires' visibility and profile. An individual circuit is closed each time a secondary sensor [302a]-[305c] is pressed by the user's thumb. In this embodiment each circuit is closed by means contained within each of the secondary sensors [302a]-[305c] with each circuit having two wires running from the secondary circuit to the controller.

The controller [307] is connected to a power source [310]. In the preferred embodiment the power source [310] is a small battery. Other power sources are within the scope of the instant invention.

The controller [307] is also connected to a transmitter [309]. The controller [307] is configured to control the transmitter [309] such that the transmitter [309] sends various signals to a receiver [312] within an electronic device [311] in a manner controlled by the closing and opening of the various circuits created by touching the various secondary sensors [302a]-[305c] with the user's thumb. In the preferred embodiment the transmitter [309] is a Bluetooth, and the electronic device [311] is a mobile phone or tablet or audio player.

What is claimed is:

1. A method for one-handed, eyes-free controlling of an electronic device comprising the steps of:
a) Wearing a glove, said glove including a primary sensor and a secondary sensor;
b) Closing a circuit by touching said primary sensor and said secondary sensor; and
c) Sending a signal to an electronic device that said circuit has been closed.

2. The method of claim 1 further comprising the step al) of configuring the electronic device to perform a specified function upon receiving said signal.

3. The method of claim 2 wherein said glove includes more than one secondary sensors and more than one circuits.

4. The method of claim 3 further comprising the step d) of sending a different signal to said electronic device upon closing different circuits.

5. The method of claim 2 wherein said electronic device is a mobile phone.

6. The method of claim 2 wherein said electronic device is a tablet.

7. The method of claim 2 wherein said electronic device is a television.

8. The method of claim 2 wherein said electronic device is a computer.

9. The method of claim 2 wherein said electronic device is a radio.

10. The method of claim 2 wherein said specified function is to accept a phone call.

11. The method of claim 2 wherein said specified function is to end a phone call.

12. The method of claim 2 wherein said signal is an electromagnetic signal.

13. A system for one-handed, eyes-free controlling of electronic devices comprising:
A glove, said glove including a primary sensor and a secondary sensor;
A circuit completed by contacting said primary sensor and said secondary sensor;
A means to communicate completing of said circuit with an electronic device.

14. The system of claim 13 further comprising a program to couple a specific function of said electronic device with closing of said circuit.

15. The system of claim 13 further comprising more than one said secondary sensors and a number of said circuits equal to the number of said secondary sensors.

16. The system of claim 15 further comprising a program to couple a different specific function of said electronic device with completion of each said circuits, said different specific functions equal to the number of said secondary sensors.

17. The system of claim 14 wherein said means to interface said circuit with said electronic device is a Bluetooth.

18. The system of claim 14 wherein said means to interface said circuit with said electronic device is via wires.

19. The system of claim 14 wherein said means to interface said circuit with said electronic device is via electromagnetic wave.

20. The system of claim 14 wherein said electronic device is a mobile phone.
